(19) United States
(12) Patent Application Publication
(10) Pub. No.: US 2008/0314352 A1
(43) Pub. Date: Dec. 25, 2008

(54) Edge-pivot charge-motion control valve system for an internal combustion engine manifold runner

(76) Inventors: Michael R. Brosseau, Rochester, NY (US); Keith A. Confer, Flushing, MI (US); Brett M. Campbell, Farmington, NY (US); Debra L. Benson, Penfield, NY (US)

Correspondence Address: Patrick M. Griffin, Esq.;Delphi Technologies, Inc., Mail Code 480410202, P.O. Box 5052, Troy, MI, 48007, US

(21) Appl. No.: 11/820,634

(22) Filed: Jun. 20, 2007

(51) Int. Cl. F02M 35/10

(52) U.S. Cl. 123/184.56

(57) ABSTRACT

An edge-pivot charge-motion control assembly for controlling air turbulence comprising a molded sleeve inserted into a runner port of an intake manifold of an internal combustion engine. A control valve element is pivotably mounted in the sleeve for external actuation. The valve element pivots into a formed recess in a wall of the sleeve and thus may be fully removed as desired from the air stream. The system allows customizing of the valve shape and also the entrance and exit geometry of the runner sleeve as desired for any engine intake manifold, thus affording great flexibility in use with a series of engines of various displacements using essentially the same head. The charge motion function between engines, and even between runners in a given engine, can be changed inexpensively by changing a small, relatively inexpensive mold tool, rather than a large, very expensive manifold mold tool.

### TECHNICAL FIELD

The present invention relates to valves for controlling flow of gas through a runner in an intake manifold of an internal combustion engine; more particularly, to such a valve that is edge-pivoted; and most particularly, to a system comprising a valve insert for insertion into an intake manifold runner wherein an edge-pivoted valve element is pivotable to be entirely out of the flow of a gas charge passing through the valve insert.

### BACKGROUND OF THE INVENTION

It is known in the internal combustion engine arts to provide variable valve mechanisms in the runners of the intake air manifold to provide charge motion control. The “charge” refers to the air or air-fuel mixture entering the combustion chamber, and the “motion” refers to the swirling, tumbling motion of that mixture. A charge-control valve serves to disrupt the laminarity of air or air/fuel mixture moving along the intake manifold runner and imparts a specific turbulent motion to the mixture entering the cylinder head. This motion is desirable to promote complete atomization of the fuel in the air stream and to insure even distribution of the air and fuel. A well atomized, homogeneous mixture of air and fuel results in better burn characteristics in the cylinder and allows for more efficient engine operation. Most cylinder heads are designed for good mixture motion at high flow conditions, so a charge motion control valve is needed only for lower rpm or idle conditions to promote charge motion by guiding the flow. During higher flow conditions the valve elements are removed from the flow path to avoid flow restriction. Such restriction can be undesirable at very high air flows wherein high turbulence is already inherent in the flow, and flow restriction should be minimized.

Butterfly-type pivoting valves are well known. The valve element itself is mounted on a pivotable shaft mounted transversely of the air flow path through the runner. In some older prior art embodiments, the shaft is mounted approximately centrally on the valve element, which provides a force-balance valve requiring minimal power for actuation. However, a drawback of this arrangement is that the valve and the shaft, even in the wide open position, create a very large obstruction to the air flow through the runner, which is highly undesirable at high air flow rates in modern engines. In some newer prior art embodiments, the shaft is mounted along an edge of the valve element. Both the valve element and the cross-sectional shape of the runner are rectanguloid such that the valve element can lie essentially flat against a wall of the runner in the wide open position. While this arrangement reduces somewhat the air drag caused by the valve element, drawbacks of this arrangement are that the valve is no longer force-balanced and that the valve, although improved, still creates significant air drag and turbulence in the runner even when wide open.

It is further known in the art to provide recesses and other configurations of a manifold runner to assist in moving the valve out of the flow path to a greater extent; however, these approaches require very costly modification and specialization of manifold molds to accommodate the individual manifold valves in a multiple-cylinder engine. Such modifications can be difficult and expensive to produce and to revise.

What is needed in the art is a simple means for mounting an edge-pivot valve element in a manifold runner wherein the valve element may be removed completely from interference with the air stream in the valve-open position and wherein no or minimal modification of a manifold mold is required.

It is a principal object of the present invention to remove a charge-motion valve element from the air stream in a manifold runner at minimum overall cost and complexity.

### SUMMARY OF THE INVENTION

Briefly described, a system in accordance with the invention comprises a molded sleeve that is insertable into a runner of an intake manifold. A control valve element is pivotably mounted in the sleeve for external actuation. The valve element pivots into a recess formed in a wall of the sleeve and thus may be fully removed from the air stream. The system allows customizing of the valve shape and also the entrance and exit geometry of the runner sleeve as may be desired for any engine intake manifold, thus affording great flexibility in use with a series of engines of various displacements using essentially the same head. The charge motion function between engines, and even between runners in a given engine, can be changed inexpensively by changing a small, relatively inexpensive mold tool, rather than a large, very expensive manifold mold tool.

### BRIEF DESCRIPTION OF THE DRAWINGS

The present invention will now be described, by way of example, with reference to the accompanying drawings, in which:

FIG. 1 is an exploded isometric view of a system in accordance with the present invention comprising a molded sleeve that is insertable into a runner of an intake manifold;

FIG. 2 is an exploded isometric view like that shown in FIG. 1, showing the sleeve assembled;

FIG. 3 is a cutaway isometric view of the system shown in FIGS. 1 and 2, assembled and showing the range of actuation of a charge-motion valve element therein; and

FIG. 4 is a cross-sectional view of the system shown in FIGS. 1 and 2, assembled and showing the range of actuation of a charge-motion valve element therein.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

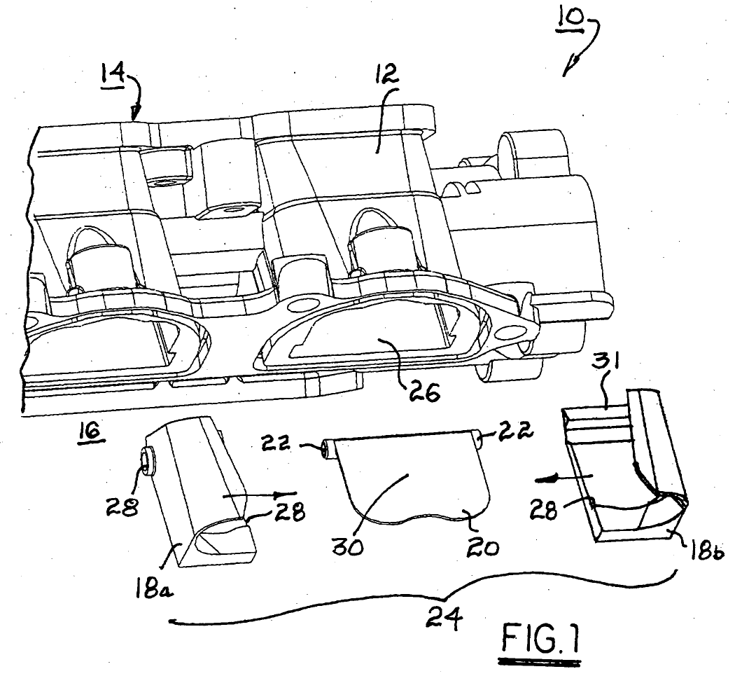

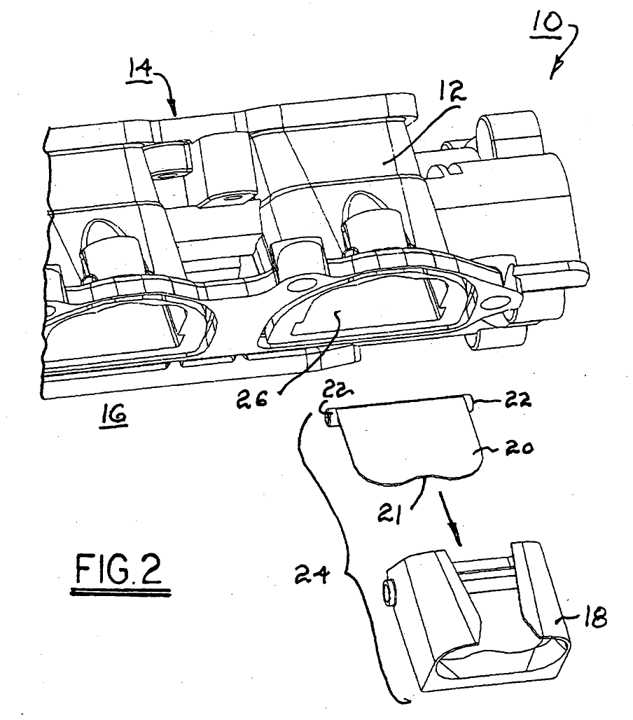

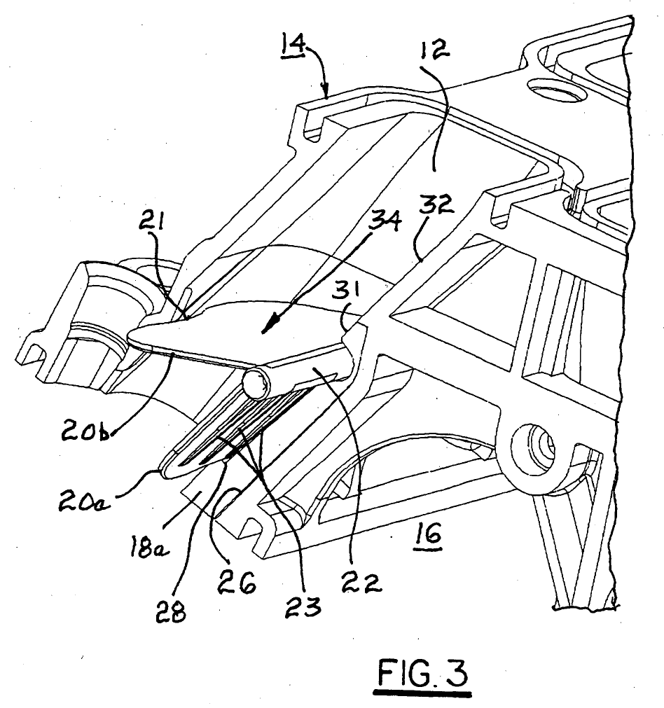

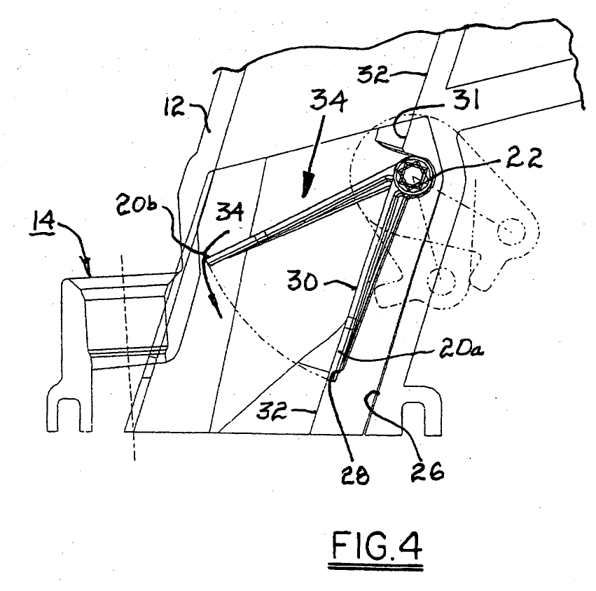

Referring to FIGS. 1 through 4, a system 10 for varying charge motion in a runner 12 of an intake manifold 14 of an internal combustion engine head 16 includes a molded sleeve 18, formed preferably of a high-temperature plastic, containing an edge-pivot valve element 20 and valve pivot 22, which collectively define an insert assembly 24 that is insertable into a runner port 26, preferably at the exit end thereof, of runner 12 which port is adapted to receive assembly 24. Although sleeve 18 may be formed in one piece (FIG. 2), preferably, it is formed in two sections 18a,18b (FIG. 1) which are joinable in known fashion as by thermal or frictional welding to capture valve pivots 22 in molded valve journals 28.

Assembly 24 is retained in runner port 26 by assembly of manifold 14 to head 16 during engine assembly. When assembled, valve element 20 is capable of a range of charge motion control positions by rotational control (not shown) of valve pivot 22 from wide open 20a to essentially closed 20b. A notch 21 preferably is provided in the outer edge of element 20 to permit air passage under very low flow demand such as at engine idle. Element 20 also is preferably reinforced by a plurality of molded ribs 23 on the underside thereof.

A recess 28 is formed in the inner wall 30 of sleeve 18 for receiving valve element 20 in the valve-open position, making the upper surface 30 of valve element 20 and sleeve wall 31 flush with inner runner wall 32 such that valve element 20 presents no obstruction to flow of air 34 through assembly 24 when the valve element is in position 20a.

Note that runner port 26 is modified to accept insertion of assembly 24. Such modification can be readily and inexpensively applied to any manifold mold, and the internal contours of sleeve 18 and the exit opening of the sleeve may be reduced or enlarged to provide optimal tumble of air 34 for particular engine family displacements, all without making expensive changes in the manifold mold and the manifold seal. Further, the valve elements 20, being cast from high temperature plastic, have lower mass than prior art metal valve elements, reducing torque requirements for actuation, reducing manufacturing cost, and allowing increasingly rapid response times.

Note further that sleeve 18 may contain all or part of a seal interface to mating components such as a seal surface, seal groove, or weld joint geometry. Sleeve 18 may or may not be part of a subassembly comprising a plurality of such sleeves and such valve elements (not shown) with a common shaft, and multiple charge-motion control valves can be assembled as a system directly to the manifold; that is, all the valve elements on one side of an intake manifold having a plurality of runners may be aligned and may be operated for gang actuation by a common shaft and rotary actuator.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for varying the turbulent motion of intake air charge flowing through an intake manifold runner to a combustion cylinder of an internal combustion engine, comprising:
a) a port in said manifold runner;
b) a valve assembly inserted into said port, said valve assembly including a sleeve and a valve element rotatable within said sleeve to vary said turbulent motion.

2. A system in accordance with claim 1 wherein said port is selected from the group consisting of a runner entrance port and a runner exit port.

3. A system in accordance with claim 1 wherein said molded sleeve includes a recess in a wall thereof for receiving said valve element such that said valve element can be rotated to a position wherein a surface of an outer side of said valve element is substantially flush with an inner wall of said manifold runner.

4. A system in accordance with claim 1 wherein said valve element is provided with means for rotation along an edge thereof.

5. A system in accordance with claim 4 wherein said valve element is provided with a notch along an edge thereof opposite said edge provided with said means for rotation.

6. A system in accordance with claim 3 wherein said valve element is provided with at least one reinforcing rib on a side opposite said flush surface side of said valve element.

7. A system in accordance with claim 1 wherein said sleeve is formed by joining of a plurality of separate pieces.

8. A system in accordance with claim 1 wherein said sleeve and said valve element are formed by molding of a high temperature plastic.

9. A system in accordance with claim 1 wherein said valve assembly is one of a plurality of such valve assemblies disposed in a plurality of manifold runner ports on said engine, said plurality of valve assemblies having a plurality of valve elements and having a common shaft for ganged rotational actuation of said plurality of valve elements.

10. An internal combustion engine having an intake manifold comprising a system for varying the turbulent motion of intake air charge flowing through a runner of said manifold to a combustion cylinder, wherein said system includes
a port in said manifold runner, and
a valve assembly inserted into said port, said valve assembly including a sleeve and a valve element rotatable within said sleeve to vary said turbulent motion.
